(19) United States
(12) Patent Application Publication
(10) Pub. No.: US 2025/0070241 A1
(43) Pub. Date: Feb. 27, 2025

(54) ELECTROLYTE AND BATTERY INCLUDING ELECTROLYTE

(71) Applicant: Murata Manufacturing Co., Ltd., Nagaokakyo-shi (JP)

(72) Inventor: Yuji KINTAKA, Nagaokakyo-shi (JP)

(21) Appl. No.: 18/947,431

(22) Filed: Nov. 14, 2024

Related U.S. Application Data
(63) Continuation of application No. PCT/JP2023/026727, filed on Jul. 21, 2023.

(30) Foreign Application Priority Data
Jul. 22, 2022 (JP) 2022-117411
Dec. 2, 2022 (JP) 2022-193382

(51) Int. Cl. H01M 10/0562

(52) U.S. Cl. CPC H01M 10/0562; H01M 2300/0068

(57) ABSTRACT

An electrolyte including: a porous insulator having a pore; and a medium and a metal salt that are disposed in the pore, wherein the metal salt is at least one of an alkali metal salt and an alkaline earth metal salt, and a molar ratio of the medium to the metal salt (medium/metal salt) is 0.1 to 2.0.

### CROSS REFERENCE TO RELATED APPLICATIONS

The present application is a continuation of International application No. PCT/JP2023/026727, filed Jul. 21, 2023, which claims priority to Japanese Patent Application No. 2022-117411, filed Jul. 22, 2022, and Japanese Patent Application No. 2022-193382, filed Dec. 2, 2022, the entire contents of each of which are incorporated herein by reference.

### TECHNICAL FIELD

The present disclosure relates to an electrolyte and a battery including the electrolyte.

### BACKGROUND ART

Batteries, including an air battery, a fuel battery, and a secondary battery, are used for various applications. A battery includes a positive electrode and a negative electrode, and has an electrolyte responsible for ion transport between the positive electrode and the negative electrode.

For example, Patent Document 1 discloses an ion conductive composite (electrolyte) including an insulating structure formed of a porous coordination polymer having a metal salt coordination unsaturated site, and an anion represented by [R—SO₂—N—SO₂—R′]⁻ (R and R′ represent a fluorine atom or a fluoroalkyl group) and a metal cation (for example, Li⁺, Na⁺, or Mg²⁺) that are held in pores of the porous coordination polymer.

In addition, Patent Document 2 discloses an electrolyte modulator that can be used for a metal battery, the electrolyte modulator including: a liquid electrolyte; and a material of a metal-organic framework (MOF) that is incorporated into the liquid electrolyte to form a MOF slurry electrolyte, the MOF being a class of crystalline porous solids constructed from metal cluster nodes and organic linkers, and capable of binding anions, removing ion pairs, and enhancing cation transport upon activation and impregnation of the liquid electrolyte.

Patent Document 1: Japanese Patent No. 6222635

Patent Document 2: Japanese Patent Application Laid-Open No. 2020-508542

### SUMMARY OF THE DISCLOSURE

The present inventor has noticed that there is still a problem to be overcome in the electrolyte, and has found a need to take measures therefor. Specifically, the present inventor has found that there is room for improvement in ionic conductivity of the electrolyte.

The present disclosure has been devised in view of such a problem. That is, a main object of the present disclosure is to provide an electrolyte having more excellent ionic conductivity than before.

The present inventor has attempted to solve the above-described problems by addressing the problem in a new direction rather than addressing the problem in an extension of the prior art. As a result, the present inventor has invented an electrolyte that achieves the main object.

An electrolyte according to an embodiment of the present disclosure includes: a porous insulator having a pore; and a medium and a metal salt that are disposed in the pore, wherein the metal salt is at least one of an alkali metal salt and an alkaline earth metal salt, and a molar ratio of the medium to the metal salt (medium/metal salt) is 0.1 to 2.0.

Further, a battery according to an embodiment of the present disclosure includes the above-described electrolyte.

The present disclosure can provide an electrolyte having more excellent ionic conductivity.

### BRIEF EXPLANATION OF DRAWINGS

FIG. 1 is a conceptual diagram illustrating an example of a battery according to a second embodiment of the present disclosure.

FIG. 2 is Raman spectrums of the electrolytes of Examples 1 to 8 and Comparative Examples 1 to 2 at 550 to 600 cm-1.

FIG. 3 is Raman spectrums of the electrolytes of Examples 1 to 8 and Comparative Examples 1 to 2 at 680 to 780 cm-1.

FIG. 4 is a graph showing a relationship between molar ratio (SL/LiFSI) and ionic conductivity at room temperature.

FIG. 5 is a graph showing a relationship between molar ratio (EC/LiFSI) and ionic conductivity at room temperature.

FIG. 6 is Raman spectrums of the electrolytes of Examples 23 and 25 to 26 and Comparative Example 1 at 870 to 930 cm-1.

FIG. 7 is Raman spectrums of the electrolytes of Examples 23 and 25 to 26 and Comparative Example 1 at 680 to 800 cm-1.

### DESCRIPTION OF THE PREFERRED EMBODIMENTS

Hereinafter, the “electrolyte” and the “battery” including the electrolyte of the present disclosure will be described in more detail with reference to embodiments. While the description is made with reference to the drawings as necessary, the contents shown in the drawings are only schematically and illustratively shown for understanding the present disclosure, and the appearance, the dimensional ratio, and the like can be different from the actual ones.

The various numerical ranges referred to herein are intended to include the lower limit and upper limit numerical values themselves, for example, unless there are specific phrases used such as “less than”, “smaller than”, and “greater than”. That is, when a numerical range such as 1 to 10 is taken as an example, it is interpreted as including both the lower limit value “1” and the upper limit value “10”.

In the present specification, that an object member is substantially made of a specific material or that an object member is made of a specific material means that the object member contains the specific material in a ratio of 95 mass % or more, 97 mass % or more, 99 mass % or more, or 100 mass %. For example, that a mesoporous silica is substantially made of silica (SiO₂) means that the mesoporous silica contains silica (SiO₂) in a ratio of 95 mass % or more, 97 mass % or more, 99 mass % or more, or 100 mass %.

In the present disclosure, the “battery” means, in a broad sense, a device from which energy can be extracted using an electrochemical reaction. The “battery”, in a narrow sense, means a device including a pair of electrodes and an electrolyte, particularly a device that charges and discharges along with movement of ions. Examples of the battery include a primary battery and a secondary battery, and more specifically include a lithium battery, a magnesium battery, a sodium battery, and a potassium battery, although they are illustrative only.

In the present disclosure, unless otherwise specified, the “electrolytic solution” refers to an electrolyte according to the present disclosure excluding the porous insulator, and including the metal salt and the medium.

### First Embodiment: Electrolyte

An electrolyte according to a first embodiment of the present disclosure is used, for example, in a battery. That is, the electrolyte described in the present specification corresponds to an electrolyte for a device from which energy can be extracted by utilizing an electrochemical reaction.

As a premise, the electrolyte according to the first embodiment is used for a battery including an electrode made of lithium, magnesium, sodium, or potassium. In particular, the electrolyte is for a battery including a lithium electrode as a negative electrode. Therefore, it can also be said that the electrolyte according to the first embodiment is an electrolyte for a lithium electrode-based battery (hereinafter, also simply referred to as “lithium electrode-based electrolyte”).

Here, the “lithium electrode” used in the present specification, in a broad sense, refers to an electrode having lithium (Li) as an active ingredient (that is, an active material). In a narrow sense, the “lithium electrode” refers to an electrode containing lithium, for example, an electrode containing lithium metal or a lithium alloy, particularly such a lithium negative electrode. Although the lithium electrode may contain a component other than lithium metal or a lithium alloy, in a preferred embodiment, the lithium electrode is an electrode made of a metal body of lithium (for example, an electrode made only of lithium metal having a purity of 90% or more, preferably a purity of 95% or more, and more preferably a purity of 98% or more).

The electrolyte of the first embodiment has Li ion conductivity in the case of a lithium electrode system. The ionic conductivity of the electrolyte of the first embodiment is, for example, a value on the order of 10⁻⁴ S/cm or more at room temperature (for example, 25° C.). The method of measuring ionic conductivity will be described in detail in EXAMPLES.

The electrolyte of the first embodiment includes: a porous insulator having a pore; and a medium (medium molecule) and a metal salt that are disposed in the pore, wherein the metal salt is at least one selected from a group consisting of an alkali metal salt and an alkaline earth metal salt, and a molar ratio of the medium to the metal salt (medium/metal salt) is 0.1 to 2.0.

### (Molar Ratio (Medium/Metal Salt))

The molar ratio of the medium to the metal salt (medium/metal salt) is 0.1 to 2.0. When the molar ratio is less than 0.1 or greater than 2.0, the ionic conductivity is reduced. From the viewpoint of further improving the ionic conductivity of the electrolyte, the lower limit value of the molar ratio is preferably 0.2 and more preferably 0.3, and the upper limit value of the molar ratio is preferably 1.9, more preferably 1.5, still more preferably 1.2, particularly preferably 1.0, and very preferably 0.8. Any upper and lower limit values can be selected from the plurality of suitable numerical ranges and combined to obtain a suitable numerical range of the molar ratio (a numerical range including an upper limit value and a lower limit value). For example, the molar ratio is preferably 0.2 to 2.0.

In particular, the molar ratio (sulfolane/LiFSi) is preferably 0.1 to 1.5, more preferably 0.2 to 1.2, still more preferably 0.2 to 1.0, and particularly preferably 0.3 to 0.5. The molar ratio (ethylene carbonate/LiFSi) is preferably 0.2 to 2.0, and more preferably 0.3 to 1.0.

### —Method for Determining Molar Ratio (Medium/Metal Salt)—

The molar ratio (medium/metal salt) can be determined by the addition amount (molar ratio in the raw material state) of the medium and the metal salt constituting the electrolyte according to the embodiment. Alternatively, the molar ratio (medium/metal salt) can also be determined from the electrolyte (as a finished product).

### [Mechanism of Action]

The electrolyte of the embodiment is more excellent in ionic conductivity. Although not bound by a specific theory, the reason is presumed as follows. In the electrolyte of the embodiment, the metal salt and the medium can form a bridge structure in a specific molar ratio (medium/metal salt=0.1 to 2.0). Specifically, the electrolyte of the embodiment can form at least one of: a bridge structure in which the medium and the positive ion (more specifically, a metal ion) constituting the metal salt are alternately arranged (hereinafter, also referred to as “first bridge structure”), and a bridge structure in which the positive ion constituting the metal salt and the negative ion constituting the metal salt are alternately arranged (hereinafter, also referred to as “second bridge structure”).

When the first bridge structure and the second bridge structure are arranged in the pore of the porous insulator, defects (holes) in which metal ions are partly missing are formed, which can be paths through which metal ions are efficiently transported in the electrolyte. Therefore, in the electrolyte of the embodiment, the bridge structure is formed in the pore of the porous insulator to improve the ionic conductivity of metal ions.

### (Trigger for Creating Present Disclosure)

When a porous insulator is impregnated with an electrolytic solution to be used for a lithium ion battery, the ionic conductivity is still low.

The present inventor has intensively studied the concept of enhancing the ionic conductivity. As a result, the present inventor has found that higher ionic conductivity is obtained when a bridge structure is formed in the pores and metal ions propagate through at least one of the first bridge structure and the second bridge structure in the pores, than when only the mechanism that solvated metal ions propagate through the pores works.

As a result, the present inventor has arrived at the electrolyte of the embodiment that enhances ionic conductivity by introducing a mechanism that is totally new and not included in the conventional concept: carrier transport by at least one of the first bridge structure and the second bridge structure.

### (First Bridge Structure)

The electrolyte of the embodiment preferably has the first bridge structure from the viewpoint of further improving ionic conductivity. In the first bridge structure, the medium and the positive ion constituting the metal salt are alternately arranged, and some of the positive ions (metal ions) are missing. The first bridge structure will be described in detail with reference to Chemical Formula 1 below:

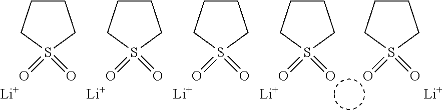

As an example of the electrolyte of the embodiment, Chemical Formula 1 exemplifies an electrolyte containing sulfolane as a medium and a metal salt constituted by a metal ion Li⁺ (sulfolane-Li⁺-based electrolyte) in the pores of the porous insulator. In the first bridge structure of the sulfolane-Li⁺-based electrolyte, (an oxygen atom of) the sulfonyl group of sulfolane is coordinated to Li⁺, sulfolane and Li⁺ are alternately arranged one-dimensionally, and Li⁺ is partly missing to from a defect (dashed circle in Chemical Formula 1). When the first bridge structure is viewed from the viewpoint of Li⁺, adjacent Li⁺s are bridged by sulfolane in the first bridge structure. Since Li⁺ defects are present, adjacent Li⁺s with sulfolane interposed therebetween can move to the defects. As described above, it is considered that Li⁺ can sequentially move in the first bridge structure, and thereby the first bridge structure contributes to efficient transport of metal ions in the electrolyte, and realizes more excellent ionic conductivity.

In the first bridge structure, one-dimensional arrangement means, for example, that sulfolane and Li⁺ are linearly arranged. However, the arrangement mode of sulfolane and Li⁺ is not limited thereto. For example, the arrangement of sulfolane and Li⁺ may be two-dimensional or three-dimensional, and more specifically, the linear arrangement may be curved or branched.

### (Method of Confirming First Bridge Structure)

The first bridge structure can be confirmed by structural analysis by Raman spectroscopy. As described above, the first bridge structure can be constructed by coordinating metal ions of the metal salt to the medium. That is, the metal ion forms a coordinate bond with a specific functional group of the medium, whereby the first bridge structure can be constructed. Therefore, the presence of the first bridge structure can be confirmed by using microscopic Raman spectroscopy to confirm that “a peak derived from a specific vibration of a coordinate-bonded functional group is shifted to the higher wave number side as compared with the peak derived from the specific vibration of the functional group in the non-coordinated state”.

For example, the presence of the first bridge structure of the sulfolane-Li⁺-based electrolyte can be confirmed by using microscopic Raman spectroscopy to confirm that “in a Raman spectrum, the peak (Raman scattering peak) derived from SO₂ bending vibration of the sulfonyl group of the medium is shifted to the higher wave number side”. The presence of the first bridge structure can be confirmed when the peak assigned to O═S=O bending vibration of the sulfonyl group coordinated to the metal ion is shifted to the higher wave number side as compared with the peak (known peak) assigned to O=S=O bending vibration of the sulfonyl group not coordinated to a metal ion.

The presence of the first bridge structure of the ethylene carbonate-Li⁺-based electrolyte can be confirmed when the peak derived from respiratory vibration of the heterocycle of the medium (ethylene carbonate) is shifted to the higher wave number side. The presence of the first bridge structure in the γ-butyrolactone (GBL)-Li⁺-based electrolyte can be confirmed when the peak derived from stretching vibration of the heterocycle of the medium (GBL) is shifted to the higher wave number side.

The method for confirming the first bridge structure will be described in detail in Examples.

### (Second Bridge Structure)

The electrolyte of the embodiment preferably has the second bridge structure from the viewpoint of further improving ionic conductivity. In the second bridge structure, the positive ion constituting the metal salt and the negative ion constituting the metal salt are alternately arranged. The second bridge structure will be described in detail with reference to Chemical Formula 2 below:

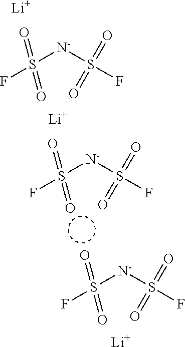 [SMILES: [Li+] ; O=S(=O)(F)[N-]S(=O)(=O)F ; [Li+] ; O=S(=O)(F)[N-]S(=O)(=O)F ; O=S(=O)(F)[N-]S(=O)(=O)F ; [Li+]]

As an example of the electrolyte of the embodiment, Chemical Formula 2 exemplifies an electrolyte containing a metal salt constituted by a metal ion Li⁺ and a bis(fluorosulfonyl)imide ion (FSI ion) as a negative ion (Li⁺-FSI-based electrolyte) in the pores of the porous insulator. In the second bridge structure of the Li⁺-FSI-based electrolyte, (an oxygen atom of) a sulfonyl group of the FSI ion is coordinated to Li⁺, the FSI ion and Li⁺ are alternately arranged one-dimensionally, and Li⁺ is partly missing to from a defect (dashed circle in Chemical Formula 2). When the second bridge structure is viewed from the viewpoint of Li⁺, adjacent Li⁺s are bridged by the FSI ion in the second bridge structure. Since Li⁺ defects are present, adjacent Li⁺s with the FSI ion interposed therebetween can move to the defects. As described above, it is considered that Li⁺ can sequentially move in the second bridge structure, and thereby the second bridge structure contributes to efficient transport of metal ions in the electrolyte, and realizes more excellent ionic conductivity.

In the second bridge structure, one-dimensional arrangement means, for example, that the FSI ion and Li⁺ are linearly arranged. However, the arrangement mode of the FSI ion and Li⁺ is not limited thereto. For example, the arrangement of the FSI ion and Li⁺ may be two-dimensional or three-dimensional, and more specifically, the linear arrangement may be curved or branched.

### (Method of Confirming Second Bridge Structure)

The second bridge structure can be confirmed by structural analysis by Raman spectroscopy. As described above, the second bridge structure can be constructed by coordinating metal ions of the metal salt to the negative ion. That is, the metal ion forms a coordinate bond with a specific functional group of the negative ion, whereby the second bridge structure can be constructed. Therefore, the presence of the second bridge structure can be confirmed by using microscopic Raman spectroscopy to confirm that “a peak derived from a specific vibration of a coordinate-bonded functional group is shifted to the higher wave number side as compared with the peak derived from the specific vibration of the functional group in the non-coordinated state”.

For example, for the metal salt LiFSI, the presence thereof can be confirmed by using microscopic Raman spectroscopy to confirm that “in Raman spectrum, the peak derived from S—N—S stretching vibration of the negative ion constituting the metal salt is shifted to the higher wave number side”. For example, when the negative ion constituting the metal salt is the FSI ion, the presence thereof can be confirmed when the peak assigned to S—N—S stretching vibration of the sulfonyl group coordinated to the metal ion is shifted to the higher wave number side as compared with the peak (known peak) assigned to S—N—S stretching vibration of the sulfonyl group not coordinated to a metal ion. The method for confirming the second bridge structure will be described in detail in Examples.

The electrolyte of the embodiment may be a solid electrolyte.

The electrolyte of the embodiment includes a porous insulator, a medium, and a metal salt. The electrolyte of the embodiment may further include components other than these components (porous insulator, medium, and metal salt) as long as the main effects of the present disclosure are exhibited. Hereinafter, these components constituting the electrolyte will be described.

### (Porous Insulator)

The porous insulator has the medium and the metal salt that are disposed in the pore thereof. As a result, the electrolyte of the first embodiment easily forms the first bridge structure and the second bridge structure contributing to more excellent ionic conductivity. The porous insulator has pores. For example, the porous insulator is at least one selected from the group consisting of a metal organic framework, a zeolite, and a mesoporous silica.

The porous insulator is preferably a zeolite or a mesoporous silica from the viewpoint of improving the ionic conductivity of the electrolyte. Although not bound by a specific theory, the reason is presumed as follows. When the electrolyte of the embodiment contains at least one (is at least one) of a zeolite or a mesoporous silica as the porous insulator, it is considered that silanol groups (Si—OH) present on the pore inner wall of the zeolite and the mesoporous silica function as a hopping site for carriers (the positive ion of the metal salt, more specifically Li⁺, etc.). More specifically, it is considered the proton (H⁺) of the silanol group and the carrier are exchanged so that the silanol group functions as a hopping site for carriers. Therefore, when the electrolyte contains at least one of a zeolite and a mesoporous silica as the porous insulator, the ionic conductivity of the electrolyte is further improved.

Among the porous insulators, from the viewpoint of improving the ionic conductivity of the electrolyte, the zeolite and the mesoporous silica have a Si/Al ratio of, for example, 5 or more, preferably 15 or more, more preferably 30 or more, further preferably 100 or more, particularly preferably 500 or more, and very particularly preferably 770 or more. The Si/Al ratio is, for example, 10,000 or less. The upper limit value and the lower limit value can be arbitrarily combined to form a numerical range (for example, 5 to 10,000). In the present specification, the Si/Al ratio refers to the molar ratio of Si (silicon atoms) with respect to Al (aluminum atoms) constituting the porous insulator.

When the Si/Al ratio is 5 or more, the zeolite and the mesoporous silica can have more silanol groups on the pore inner wall thereof. In this case, it is considered that more hopping sites for carriers can be present on the pore inner wall of the zeolite and the mesoporous silica, and the ionic conductivity of the electrolyte is further improved.

The Si/Al ratio of the zeolite and the mesoporous silica is measured as follows. The zeolite or mesoporous silica is pulverized such that it can be measured, and placed in a nuclear magnetic resonance apparatus (“ECA 400 type FT-NMR apparatus” manufactured by JEOL Ltd.). NMR spectrum is measured under measurement conditions of a magnetic field strength of 9.2 T and a nuclide: 29Si. The Si/Al ratio is obtained by spectral analysis.

The zeolite or mesoporous silica used for the measurement of the Si/Al ratio can be measured not only in the state of a raw material but also in a state of being separated from the finished product (for example, an electrolyte or a battery including an electrolyte (more specifically, a measurement cell battery described later in Examples)).

Examples of commercially available products of the metal organic framework include “UiO-67”, “HKUST-1”, and “F-free MIL-100 (Fe) (KRICT (trademark) F100)”, each of which is manufactured by Strem Chemicals, and “ZIF-8 (Basolite (registered trademark) (Z1200)” and “MIL-53 (Basolite A100)”, each of which is manufactured by MERCK. Examples of commercially available products of zeolite include “HS-690”, “HS-642”, and “HS-320”, each of which is manufactured by FUJIFILM Wako Pure Chemical Corporation, and “HSZ-360HUA”, “HSZ-385HUA”, “HSZ-390HUA”, “HSZ-660HOA”, “HSZ-840HOA”, “HSZ-890HOA”, and “HSZ-980HOA”, each of which is manufactured by Tosoh Corporation. Examples of commercially available products of mesoporous silica include “MCM-41”, “MCM-48”, “SBA-15”, and “SBA-16”, each of which is manufactured by Sigma-Aldrich Co. LLC.

### (Medium)

The medium is an electrically neutral molecule. The medium disperses, dissolves, or solid-solves the metal salt in the electrolyte. The medium is preferably at least one of a sulfonyl-based medium, a carbonate-based medium, an ether-based medium, and a dioxolane-based medium. Among them, the medium is preferably a carbonate-based medium.

The sulfonyl-based medium is a medium having a sulfonyl group, and is selected from the group consisting of, for example, sulfolane, dimethylsulfone, 3-methylsulfone, and ethylmethylsulfone.

The carbonate-based medium is a cyclic carbonate ester compound (more specifically, a 5-membered ring or 6-membered ring alkylene carbonate compound having 3 to 6 carbon atoms), and is selected from the group consisting of, for example, ethylene carbonate, propylene carbonate, vinylene carbonate, and fluoroethylene carbonate. The carbonate-based medium may have a halogen group (more specifically, fluoro group and the like) and a C═C double bond.

The chain ether-based medium is a compound containing 2 to 4 ether bonds, and is, for example, selected from the group consisting of 1,2-diethoxyethane and diglyme.

The lactone-based medium is a cyclic ester compound (more specifically, a 5-membered ring or 6-membered ring ester compound having 4 to 7 carbon atoms), and is selected from the group consisting of, for example, γ-butyrolactone and δ-valerolactone.

The cyclic ether-based medium is a 5- or 6-membered oxygen-containing heterocyclic compound having two oxygen atoms as ring member atoms, and is selected from the group consisting of dioxolane (1,3-dioxolane) and dioxane (more specifically, 1,3-dioxane and the like).

The medium that is at least one of these easily forms the first bridge structure with a metal ion constituting the metal salt in the electrolyte. Therefore, in such a case, the electrolyte of the embodiment has further enhanced ionic conductivity.

### (Metal Salt)

The metal salt is at least one selected from the group consisting of an alkali metal salt and an alkaline earth metal salt. Examples of the metal salt include an alkali metal salt (more specifically, a lithium metal salt or the like). Examples of the lithium metal salt include lithium bis(fluorosulfonyl)imide (LiFSI), lithium bis(trifluoromethanesulfonyl)imide (LiTFSI), lithium tetrafluoroborate (LiBF₄), and lithium perchlorate (LiClO₄). Among them, the lithium salt is preferably LiFSI and LiTFSI, and more preferably LiFSI. Examples of the alkali metal ion constituting the alkali metal salt include Li⁺, Na⁺, and K⁺. Examples of the alkaline earth metal ion constituting the alkaline earth metal salt include Mg²⁺. The metal ion (positive ion) constituting the metal salt is preferably Li⁺, K⁺, Na⁺, or Mg²⁺. From the viewpoint of further enhancing the ionic conductivity of the electrolyte of the embodiment, the negative ion constituting the metal salt is preferably coordinated to the positive ion constituting the metal salt to form the second bridge structure with the positive ion (metal ion) constituting the metal salt. The negative ion constituting the metal salt is, for example, at least one selected from a group consisting of a bis(fluorosulfonyl) imide ion (FSI ion), a bis(trifluoromethanesulfonyl) imide ion (TFSI ion), a tetrafluoroborate ion, and a perchlorate ion.

### (Method for Producing Electrolyte)

An example of the method for producing the electrolyte of the first embodiment will be described. The method for producing the electrolyte of the first embodiment includes the steps of: preparing an electrolytic solution containing a metal salt and a medium (electrolytic solution preparation step); and impregnating a porous insulator having a pore with the electrolytic solution (impregnation step).

### —Electrolytic Solution Preparation Step—

In the electrolytic solution preparation step, an electrolytic solution containing a metal salt and a medium is prepared.

### —Impregnation Step—

In the impregnation step, a porous insulator having a pore is impregnated with the electrolytic solution. As a result, the pores of the porous insulator are filled with the electrolytic solution. When the prepared electrolytic solution is not a liquid at room temperature (25° C.) (for example, solid, pseudo-solid (more specifically, a liquid in which a solid is mixed)), the electrolytic solution can be heated to become a liquid state, and impregnated into the porous insulator.

### Second Embodiment: Battery

The battery of the second embodiment includes the electrolyte of the first embodiment. The battery of the second embodiment may further include a positive electrode and a negative electrode in addition to the electrolyte.

In the battery of the embodiment, the positive electrode contains a material constituting the positive electrode (more specifically, a positive electrode active material and the like). The negative electrode contains an alkali metal (more specifically, Li, Na, and K) or an alkaline earth metal (more specifically, Mg) as a material constituting the negative electrode (specifically, a negative electrode active material). The negative electrode contains, for example, a simple substance of an alkali metal or an alkaline earth metal (more specifically, a plate, a foil, and a layer) and a compound thereof.

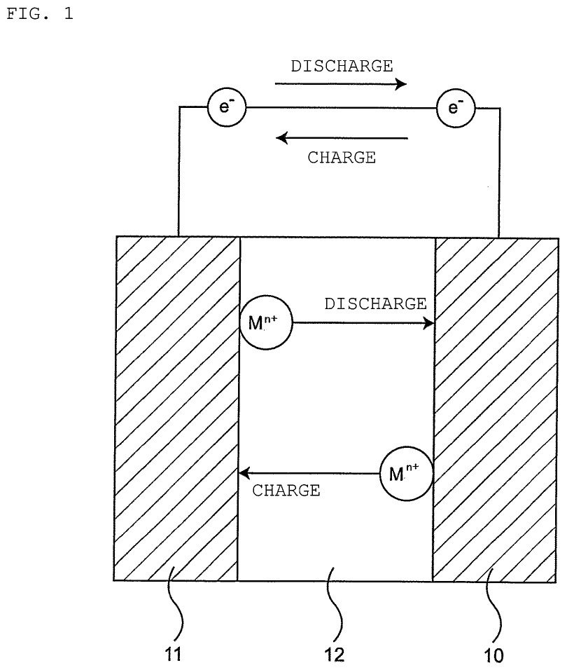

The battery of the embodiment can be configured as a secondary battery. FIG. 1 shows a conceptual diagram in this case. As shown, during charging, metal ions (Mⁿ⁺ (M represents a metal element, and “n” represents a positive integer.): more specifically, Li⁺, Na⁺, K⁺, Mg²⁺, and the like) move from a positive electrode 10 through an electrolyte 12 to a negative electrode 11, thereby converting electrical energy into chemical energy for storage. During discharging, metal ions return from the negative electrode 11 to the positive electrode 10 through the electrolyte 12 to generate electric energy.

The battery of the second embodiment can be used as a driving power source or an auxiliary power source of, for example, a notebook type personal computer, a personal digital assistant (PDA), a mobile phone, a smart phone, a master unit and a slave unit of cordless phone, a video movie, a digital still camera, an electronic book, an electronic dictionary, a portable music player, a radio, a headphone, a game machine, a navigation system, a memory card, a cardiac pacemaker, a hearing aid, an electric tool, an electric shaver, a refrigerator, an air conditioner, a television receiver, a stereo, a water heater, a microwave oven, a dishwasher, a washing machine, a dryer, a lighting apparatus, a toy, a medical device, a robot, a road conditioner, a traffic light, a railway vehicle, a golf cart, an electric cart, and/or an electric car (including a hybrid car). In addition, the battery can be mounted on a building such as a house, a power source for power storage that is used for power generation facilities, or the like, or can be used in order to supply electric power thereto. In an electric car, a conversion device that converts electric power into a driving force by supplying electric power is generally a motor. Examples of the control device (control unit) that processes information related to vehicle control includes a control device that displays the remaining battery level based on information on the remaining battery level. The battery can also be used in an electric storage device in a so-called smart grid. Such a power storage device can not only supply electric power but also store electric power by receiving electric power supply from other power source. As the “other power source”, for example, thermal power generation, nuclear power generation, hydroelectric power generation, a solar battery, wind power generation, geothermal power generation, and/or a fuel cell (including a biofuel cell), or the like can be used.

Although the embodiments of the present disclosure have been described above, typical examples have been only illustrated. Accordingly, those skilled in the art will easily understand that the present disclosure is not limited thereto, and various embodiments are conceivable without changing the scope of the present disclosure.

For example, the composition of the electrolyte, the raw materials used for production, the production method, the production conditions, the characteristics of the electrolyte, and the configuration or structure of the battery described above are examples, and the present disclosure is not limited to these, and those can be changed appropriately. Examples of the battery include a lithium battery, a magnesium battery, a sodium battery, a potassium battery, an air battery, a fuel battery, and the like.

### EXAMPLES

Hereinafter, the present disclosure will be described more specifically with reference to Examples; however, the present disclosure is not limited to these Examples.

### Example 1

### [1. Preparation of Electrolytic Solution]

### (1-1. Raw Materials)

The following raw materials were used.

### —Porous Insulator: Metal Organic Framework (MOF)—

“UiO-67”, manufactured by Strem Chemicals: MOF represented by Zr₆O₄(OH)₄(BPDC)₆ (BPDC: biphenyldicarboxylate)
“HKUST-1”, manufactured by Strem Chemicals: MOF made of Cu and 1,3,5-benzenetricarboxylic acid
“ZIF-8 (Basolite (Z1200 (trademark))”, manufactured by MERCK: zeolite-imidazolate structure (ZIF): MOF made of Zn and 2-methylimidazole
“F-free MIL-100 (Fe) (KRICT (trademark) F100)”, manufactured by Strem Chemicals: Fe₃(O)(OH)(C₉H₃O₆)₂: (MOF made of Fe and 1,3,5-benzenetricarboxylic acid)
“MIL-53 (Basolite A100)”, manufactured by MERCK: Al(OH)C₈H₄O₄

### —Porous Insulator: Zeolite—

“HS-320”, manufactured by FUJIFILM Wako Pure Chemical Corporation (crystal system: Y-type, Si/Al ratio=5.5, cation species: H; hereinafter, also referred to as “HS-320 (H)”).
“HS-320”, manufactured by FUJIFILM Wako Pure Chemical Corporation (crystal system: Y-type, Si/Al ratio=5.5, cation species: Na; hereinafter, also referred to as “HS-320 (Na)”)
“HS-642”, manufactured by FUJIFILM Wako Pure Chemical Corporation (crystal system: mordenite, Si/Al ratio=18, cation species: Na)
“HS-690”, manufactured by FUJIFILM Wako Pure Chemical Corporation (crystal system: mordenite, Si/Al ratio=180, cation species: H)
“HSZ-360HUA”, manufactured by Tosoh Corporation (crystal system: Y-type, Si/Al ratio=15, cation species: H)
“HSZ-385HUA”, manufactured by Tosoh Corporation (crystal system: Y-type, Si/Al ratio=100, cation species: H)
“HSZ-390HUA”, manufactured by Tosoh Corporation (crystal system: Y-type, Si/Al ratio=770, cation species: H)
“HSZ-660HOA”, manufactured by Tosoh Corporation (crystal system: mordenite, Si/Al ratio=30, cation species: H)
“HSZ-840HOA”, manufactured by Tosoh Corporation (crystal system: ZSM-5, Si/Al ratio=40, cation species: H)
“HSZ-980HOA”, manufactured by Tosoh Corporation (crystal system: beta, Si/Al ratio=500, cation species: H)

### —Porous Insulator: Mesoporous Silica—

“MCM-41”, manufactured by Sigma-Aldrich Co. LLC
“MCM-48”, manufactured by Sigma-Aldrich Co. LLC
“SBA-15”, manufactured by Sigma-Aldrich Co. LLC
“SBA-16”, manufactured by Sigma-Aldrich Co. LLC

These four mesoporous silicas artificially contain no Al, and substantially made of silica (SiO₂). Therefore, it is considered that the Si/Al ratio of these mesoporous silicas is at least greater than 10,000.

### —Metal Salt—

Lithium bis(fluorosulfonyl) imide (manufactured by KISHIDA CHEMICAL CO., LTD. (for LBG); hereinafter, also referred to as “LiFSI”)
Lithium bis(trifluoromethanesulfonyl) imide (manufactured by KISHIDA CHEMICAL CO., LTD. (for LBG); hereinafter, also referred to as “LiTFSI”)
Lithium hexafluorophosphate (manufactured by KISHIDA CHEMICAL CO., LTD. (for LBG); hereinafter, also referred to as “LiPF₆” or “LiPF6”)
Lithium tetrafluoroborate (manufactured by KISHIDA CHEMICAL CO., LTD. (for LBG); hereinafter, also referred to as “LiBF₄” or “LiBF4”)
Lithium perchlorate (manufactured by KISHIDA CHEMICAL CO., LTD. (for LBG); hereinafter, also referred to as “LiClO₄” or “LiClO4”)

### —Medium: Sulfonyl-Based Medium—

Sulfolane (manufactured by KISHIDA CHEMICAL CO., LTD. (for LBG); hereinafter, also referred to as “SL”)
Dimethylsulfone (manufactured by Tokyo Chemical Industry Co., Ltd.; hereinafter, also referred to as “DMSO2”)
3-methylsulfolane (manufactured by Tokyo Chemical Industry Co., Ltd.; hereinafter, also referred to as “MSL”)
Ethylmethylsulfone (manufactured by Tokyo Chemical Industry Co., Ltd.; hereinafter, also referred to as “EMS”)

### —Medium: Carbonate-Based Medium—

Propylene carbonate (manufactured by KISHIDA CHEMICAL CO., LTD.; hereinafter, also referred to as “PC”)
Ethylene carbonate (manufactured by KISHIDA CHEMICAL CO., LTD.; hereinafter, also referred to as “EC”)
Vinylene carbonate (manufactured by KISHIDA CHEMICAL CO., LTD.; hereinafter, also referred to as “VC”)
Fluoroethylene carbonate (manufactured by KISHIDA CHEMICAL CO., LTD.; hereinafter, also referred to as “FEC”)

### —Medium: Lactone-Based Medium—

γ-butyrolactone (manufactured by KISHIDA CHEMICAL CO., LTD.; hereinafter, also referred to as “GBL”)

### —Medium: Chain Ether-Based Medium—

Diglyme (manufactured by KISHIDA CHEMICAL CO., LTD.)
1,2-dimethoxyethane (manufactured by KISHIDA CHEMICAL CO., LTD.; hereinafter, also referred to as “DME”)

### (1-2. Preparation of Solid Electrolyte)

The LiFSI as the metal salt and the sulfolane SL as the medium were mixed in a molar ratio of (medium/metal salt)=2.0 to prepare an electrolytic solution.

The UiO-67 as the porous insulator was dried under the conditions of under vacuum and at 250° C. The dried UiO-67 was impregnated with the prepared electrolytic solution, and the electrolytic solution was inserted and filled in the pores of the UiO-67. Thus, a powdery solid electrolyte was prepared. This impregnation treatment was performed by manually mixing the electrolytic solution and the porous insulator using a mortar and a pestle. The impregnation amount (volume) of the electrolytic solution was 100% of the micropore volume of the porous insulator (UiO-67), which was measured in advance.

The solid electrolyte was prepared in a glove box in an argon atmosphere.

### (1-3. Preparation of Measurement Cell Battery)

The prepared powdery solid electrolyte was pressed at 200 MPa using a uniaxial pressing machine (“CDM-20PA”, manufactured by RIKENKIKI CO., LTD). As the press mold for pressing, a PET resin die provided with upper and lower punches was used. Specifically, the PET resin die has a cylindrical shape and has a cylindrical through opening along the central axis. The punches have a cylindrical shape, are provided such that they can be inserted into and removed from the through opening of the die, and are provided such that the distal end surfaces (surfaces perpendicular to the insertion direction) of the upper and lower punches face each other. The powdery solid electrolyte was set in the through opening of the die so that the powdery solid electrolyte was sandwiched between the distal end surfaces of the upper and lower punches. The upper and lower punches were pressed with a uniaxial pressing machine to mold the solid electrolyte. Further, the upper punch and the lower punch provided on the PET resin die were used as blocking electrodes as they were to obtain a measurement cell (a cell for measurement).

The step of preparing the measurement cell was performed in a glove box in an argon atmosphere.

### [2. Measurement Method and Evaluation Method]

### (2-1. Form of Electrolytic Solution)

The appearance of the electrolytic solution (electrolytic solution made of the metal salt and the medium) obtained in the step of preparing the solid electrolyte was visually observed. Furthermore, the behavior when the container containing the electrolytic solution was inclined, and the liquid surface changes to be parallel to the horizontal plane was visually observed. Based on these observation results, determination was made according to the following evaluation criteria.

### (Evaluation Criteria)

Liquid: The appearance is liquid, no solid state is mixed, and when the cylindrical container containing the electrolytic solution is inclined such that the bottom surface of the container and the horizontal plane form 30°, the liquid surface of the electrolytic solution becomes parallel to the horizontal plane in less than 1 second after inclination.

Sherbet: The appearance is a mixture of liquid and solid, and when the cylindrical container containing the electrolytic solution is inclined such that the bottom surface of the container and the horizontal plane form 30°, the shape of the liquid surface of the electrolytic solution changes in 1 second or longer and 60 seconds or less after inclination.

Solid: The appearance is solid, and when the cylindrical container containing the electrolytic solution is inclined such that the bottom surface of the container and the horizontal plane form 30°, the liquid surface of the electrolytic solution does not change 10 minutes after inclination.

### (2-2. Measurement of Ionic Conductivity)

### —Preparation of Measurement Sample—

The measurement cell battery produced in (1-3. Preparation of measurement cell) was enclosed in a laminate with a tab electrode to obtain a cell for measuring ionic conductivity as a measurement sample.

### —Measurement of Ionic Conductivity—

The ionic conductivity of the measurement sample was measured using an impedance meter (“VMP3”, manufactured by BioLogic). The ionic conductivity was measured at room temperature (25° C.) with AC impedance method. The solid electrolyte of Example 1 had an ionic conductivity of 1.9×10⁻⁴ (S/cm) at a molar ratio (SL/LiFSI) of 2.0. The results are shown in Table 1 together with the results of appearance observation of the electrolytic solution described above. Table 1 shows the molar ratio (SL/LiFSI), the state of the electrolytic solution at room temperature, and the ionic conductivity at room temperature.

### (2-3. Structural Analysis of Electrolyte by Raman Spectroscopy)

Structural analysis was performed using Raman spectroscopy for the electrolytes of Example 1 and Examples 2 to 8 and Comparative Examples 1 to 2 described later.

The solid electrolyte molded in (1-3. Preparation of measurement cell) was used as a measurement sample for structural analysis. The obtained measurement sample was set in a micro laser Raman spectrometer (“LabRam HR Evolution”, manufactured by HORIBA, Ltd.). The surface of the measurement sample was irradiated with infrared laser light (wavelength: 1064 nm), and Raman spectrum was measured using an objective lens having a spot diameter of 7 μm. Raman spectrum may be measured by irradiating infrared laser light to a cut surface formed by cutting the measurement sample (solid electrolyte) for structural analysis.

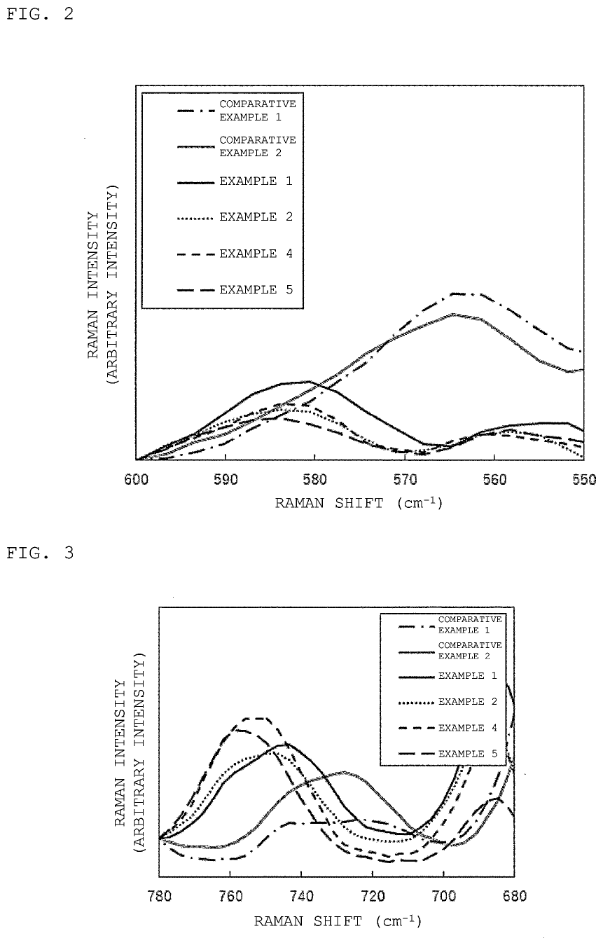

FIG. 2 shows Raman spectrums of the electrolytes of Examples 1 to 8 and Comparative Examples 1 to 2 at 550 to 600 cm⁻¹. In the Raman spectrums shown in FIG. 2, the vertical axis represents Raman intensity (unit: arbitrary intensity), and the horizontal axis represents Raman shift (unit: cm⁻¹). The Raman spectrums shown in FIG. 2 had a peak around 580 to 590 cm⁻¹. This peak was assigned to the peak that is derived from SO₂ scissor vibration (O—S—O bending vibration) of the sulfonyl group of sulfolane and originally positioned around 560 to 570 cm⁻¹, and has been shifted to the higher wave number side.

FIG. 3 shows Raman spectrums of the electrolytes of Examples 1 to 8 and Comparative Examples 1 to 2 at 680 to 780 cm⁻¹. In the Raman spectrums shown in FIG. 3, the vertical axis represents Raman intensity (unit: arbitrary intensity), and the horizontal axis represents Raman shift (unit: cm⁻¹). The Raman spectrums shown in FIG. 3 had a peak around 740 to 750 cm⁻¹ and a peak around 680 to 690 cm⁻¹. The peak around 740 to 750 cm⁻¹ was assigned to the peak that is derived from S—N—S stretching vibration of the FSI anion and originally positioned around 720 to 740 cm⁻¹, and has been shifted to the higher wave number side.

### (2-4. Determination of Si/Al Ratio by Nuclear Magnetic Resonance Method)

For some of the systems using a zeolite or a mesoporous silica as the porous insulator (Examples 41 to 46), the Si/Al ratio of the zeolite or mesoporous silica was determined.

Specifically, the zeolite or mesoporous silica was pulverized such that it can be measured. The pulverized zeolite or mesoporous silica was placed in a nuclear magnetic resonance apparatus (“ECA 400 type FT-NMR apparatus” manufactured by JEOL Ltd.). NMR spectrum was measured under measurement conditions of a magnetic field strength of 9.2 T and a nuclide: 29Si. The Si/Al ratio was obtained from the peak area intensity ratio of the 29Si NMR spectrum.

### Examples 2 to 8 and Comparative Examples 1 to 2: Molar Ratio

An electrolyte was prepared and the ionic conductivity was measured in the same manner as in Example 1 except that the molar ratio (SL/LiFSI) was changed from 2.0 to the molar ratio shown in Table 1. In addition, the appearance of the electrolytic solution obtained in the electrolyte preparation step was also observed. These results are shown in Table 1.

When the concentration of the metal salt is relatively high in the electrolytic solution including the metal salt and the medium (that is, when the concentration of the medium is relatively low), the electrolytic solution may become a solid or a liquid containing precipitated solid at room temperature (25° C.). In such a case, the electrolytic solution was heated (for example, at 100° C.) until the solid in the prepared electrolytic solution was totally dissolved, and the obtained liquid was subjected to impregnation treatment.

In Example 6, a lithium ion secondary battery including the electrolyte of Example 6, Li₄Ti₅O₁₂ as a negative electrode, and LiFePO₄ as a positive electrode was produced. Charge-discharge was performed at a current of 0.2 C (coulomb). The charge-discharge potential was about 1.8 V.

### Results: Examples 1 to 8 and Comparative Examples 1 to 2: Molar Ratio

### (Ionic Conductivity)

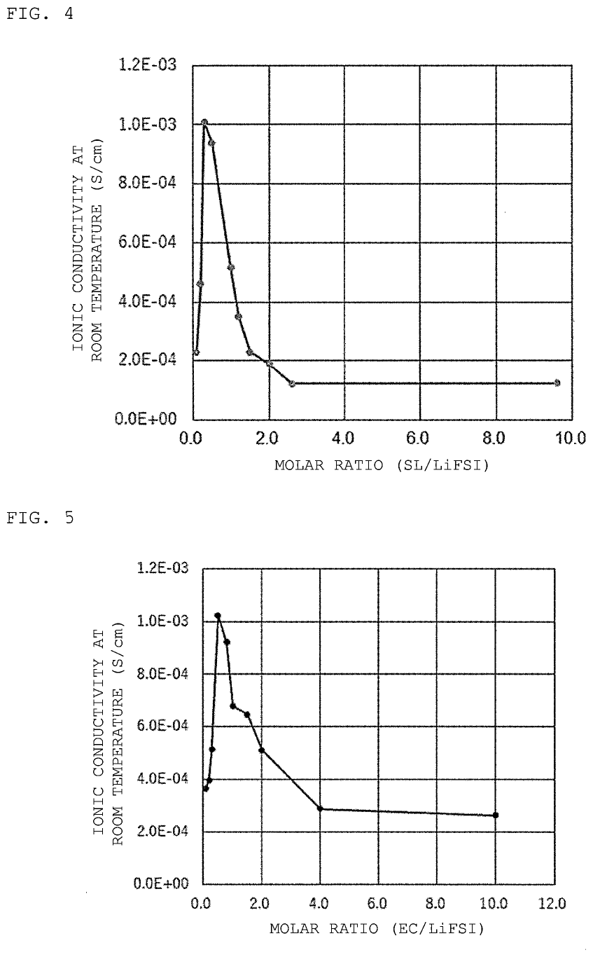

Table 1 shows the molar ratio (SL/LiFSI) and ionic conductivity at room temperature. FIG. 4 was created based on Table 1. FIG. 4 shows the relationship between molar ratio (SL/LiFSI) and ionic conductivity at room temperature. In FIG. 4, the horizontal axis represents molar ratio, and the vertical axis represents ionic conductivity (unit: S/cm) at room temperature. In the scale of the vertical axis in FIG. 4, for example, 1.0E-03 indicates 1.0×10⁻³.

TABLE 1

| | | State of | Ionic |
|---|---|---|---|
| | | electrolytic | conductivity |
| | | solution | at room |
| | Molar ratio | at room | temperature |
| | (SL*¹/LiFSI*²) | temperature | (S/cm) |
| Comparative | 9.6 | Liquid | 1.2 × 10⁻⁴ |
| Example 1 | | | |
| Comparative | 2.6 | Liquid | 1.2 × 10⁻⁴ |
| Example 2 | | | |
| Example 1 | 2.0 | Sherbet | 1.9 × 10⁻⁴ |
| Example 2 | 1.5 | Sherbet | 2.3 × 10⁻⁴ |
| Example 3 | 1.2 | Solid | 3.5 × 10⁻⁴ |
| Example 4 | 1.0 | Solid | 5.2 × 10⁻⁴ |
| Example 5 | 0.5 | Solid | 9.4 × 10⁻⁴ |
| Example 6 | 0.3 | Solid | 10.1 × 10⁻⁴ |
| Example 7 | 0.2 | Solid | 4.6 × 10⁻⁴ |
| Example 8 | 0.1 | Solid | 2.3 × 10⁻⁴ |

*¹Sulfolane,
*²Lithium bis (fluorosulfonyl) imide

In the SL-LiFSI-based electrolyte, as shown in FIG. 4, the ionic conductivity simply increased at room temperature as the molar ratio (SL/LiFSI) increased from 0.1 to 0.3, the ionic conductivity simply decreased at room temperature as the molar ratio (SL/LiFSI) increased from 0.3 to 2.6, and the ionic conductivity was almost constant at room temperature as the molar ratio (SL/LiFSI) increased from 2.6 to 9.6.

The ionic conductivity of the electrolytic solution containing SL and LiFSI in Example 4 was measured, and found to be less than or equal to the lower measurement limit (or less than or equal to the measurement limit; more specifically, about 10⁻⁷ S/cm or less). The value corresponds to the ionic conductivity of an insulator.

### (First Bridge Structure)

In the SL-LiFSI-based electrolyte, as shown in FIG. 2, the peak derived from O—S—O bending vibration (Raman scattering peak) was located at 560 to 570 cm⁻¹ when the molar ratio (SL/LiFSI) was 2.6 to 9.6, and located at 580 to 590 cm⁻¹ when the molar ratio (SL/LiFSI) was decreased to become 0.5 to 2.0. In the electrolyte of Examples 1 to 5, the peak derived from O—S—O bending vibration was shifted to the higher wave number side as compared with the electrolyte of Comparative Examples 1 to 2.

From these results, it is considered that, in the electrolyte of Examples 1 to 8, Li⁺ constituting the metal salt and SL as the medium form the first bridge structure. The first bridge structure is presumably due to a specific molar ratio (SL/LiFSI).

### (Second Bridge Structure)

In the SL-LiFSI-based electrolyte, as shown in FIG. 3, the peak derived from S—N—S stretching vibration (Raman scattering peak) was located at 720 to 740 cm⁻¹ when the molar ratio (SL/LiFSI) was 2.6 to 9.6, and located at 740 to 760 cm⁻¹ when the molar ratio (SL/LiFSI) was decreased to become 0.5 to 2.0. In the electrolyte of Examples 1 to 5, the peak derived from S—N—S stretching vibration was gradually shifted to the higher wave number side as the molar ratio (SL/LiFSI) was decreased, as compared with the electrolyte of Comparative Examples 1 to 2.

From these results, it is considered that, in the electrolyte of Examples 1 to 5, the positive ion Li⁺ and the negative ion FSI constituting the metal salt form the second bridge structure. The second bridge structure is presumably due to a specific molar ratio (SL/LiFSI).

### Comparison of Examples 1 to 8 with Comparative Examples 1 to 2

The electrolyte of Examples 1 to 8 includes: UiO-67 as the porous insulator having a pore; and SL as the sulfonyl group-containing medium and LiFSI as the metal salt that are disposed in the pore, wherein LiFSI as the metal salt is at least one selected from a group consisting of an alkali metal salt and an alkaline earth metal salt, and the molar ratio of the medium to the metal salt (medium/metal salt) is 0.1 to 2.0. That is, the electrolyte of Examples 1 to 8 was encompassed in the scope of the disclosure.

The ionic conductivity of the electrolyte of Examples 1 to 8 was 1.9×10⁻⁴ to 10.1×10⁻⁴ S/cm at normal temperature (room temperature).

The electrolyte of Comparative Examples 1 to 2 was not encompassed in the scope of the disclosure. Specifically, in the electrolyte of Comparative Examples 1 to 2, the molar ratio of the medium to the metal salt (medium/metal salt) was more than 2.0.

The ionic conductivity of the electrolyte of Comparative Examples 1 to 2 was 1.2×10⁻⁴ S/cm at normal temperature (room temperature).

Examples 1 to 8, each of which is encompassed in the scope of the disclosure, had higher ionic conductivity at normal temperature (room temperature) than Comparative Examples 1 to 2, each of which is not encompassed in the scope of the disclosure. Thus, it is apparent that the disclosure is excellent in ionic conductivity.

### Examples 9 to 14 and Comparative Examples 3 to 5: Porous Insulator

An electrolyte was prepared and a battery was produced in the same manner as in Example 1 except that UiO-67 as the porous insulator and the molar ratio (medium/metal salt) were changed to the porous insulator (metal organic insulator) and the molar ratio listed in Table 2, respectively.

In addition, the ionic conductivity was measured in the same manner as in Example 1. These results are shown in Table 2.

TABLE 2

| | | | Ionic |
|---|---|---|---|
| | | | conductivity |
| | | | at room |
| | Porous | Molar ratio | temperature |
| | insulator | (SL*¹/LiFSI*²) | (S/cm) |
| Comparative | HKUST-1 | 9.6 | 7.7 × 10⁻⁵ |
| Example 3 | | | |
| Example 9 | HKUST-1 | 1.0 | 3.0 × 10⁻⁴ |
| Example 10 | HKUST-1 | 0.5 | 4.0 × 10⁻⁴ |
| Comparative | ZIF-8 | 9.6 | 1.7 × 10⁻⁴ |
| Example 4 | | | |
| Example 11 | ZIF-8 | 1.0 | 3.5 × 10⁻⁴ |
| Example 12 | ZIF-8 | 0.5 | 4.3 × 10⁻⁴ |
| Comparative | MIL-100(Fe) | 9.6 | 9.7 × 10⁻⁵ |
| Example 5 | | | |
| Example 13 | MIL-100(Fe) | 1.5 | 2.2 × 10⁻⁴ |
| Example 14 | MIL-100(Fe) | 0.5 | 3.7 × 10⁻⁴ |

*¹Sulfolane,
*²Lithium bis (fluorosulfonyl) imide

### Comparison of Examples 9 to 14 with Comparative Examples 3 to 5

The electrolyte of Examples 9 to 14 includes: any of HKUST-1, ZIF-8, and MIL-100 (Fe) as the porous insulator (metal organic framework) having a pore; and SL as the sulfonyl group-containing medium and LiFSI as the metal salt that are disposed in the pore, wherein LiFSI as the metal salt is at least one selected from a group consisting of an alkali metal salt and an alkaline earth metal salt, and the molar ratio of the medium to the metal salt (medium/metal salt) is 0.1 to 2.0. That is, the electrolyte of Examples 9 to 14 was encompassed in the scope of the disclosure.

The ionic conductivity rate of the electrolyte of Examples 9 to 14 was 2.2×10⁻⁴ to 4.3×10⁻⁴ S/cm at normal temperature (room temperature).

The electrolyte of Comparative Examples 3 to 5 was not encompassed in the scope of the disclosure. Specifically, in the electrolyte of Comparative Examples 3 to 5, the molar ratio of the medium to the metal salt (medium/metal salt) was more than 2.0.

The ionic conductivity of the electrolyte of Comparative Examples 3 to 5 was 0.77×10⁻⁴ to 1.7×10⁻⁴ S/cm at normal temperature (room temperature).

Examples 9 to 14, each of which is encompassed in the scope of the disclosure, had higher ionic conductivity at normal temperature (room temperature) than Comparative Examples 3 to 5, each of which is not encompassed in the scope of the disclosure.

### Examples 15 to 20: Metal Salt and Medium

An electrolyte was prepared and a battery was produced in the same manner as in Example 1 except that LiFSI as the metal salt, SL as the medium, and the molar ratio were changed to the metal salt, medium, and molar ratio (medium/metal salt) listed in Table 3, respectively.

In addition, the ionic conductivity was measured in the same manner as in Example 1. These results are shown in Table 3.

TABLE 3

| | | | | Ionic |
|---|---|---|---|---|
| | | | | conductivity |
| | Metal salt | | Molar ratio | at room |
| | (Alkali | | (Medium/Metal | temperature |
| | metal salt) | Medium | salt) | (S/cm) |
| Example 15 | LiTFSI*¹ | SL*⁵ | 0.5 | 2.7 × 10⁻⁴ |
| Example 16 | LiBF₄*² | SL | 0.7 | 3.2 × 10⁻⁴ |
| Example 17 | LiClO₄*³ | SL | 2.0 | 3.5 × 10⁻⁴ |
| Example 18 | LiFSI*⁴ | DMSO2*⁶ | 1.0 | 2.9 × 10⁻⁴ |
| Example 19 | LiFSI | MSL*⁷ | 1.0 | 3.2 × 10⁻⁴ |
| Example 20 | LiFSI | EMS*⁸ | 1.0 | 3.3 × 10⁻⁴ |

*¹Bis (trifluoromethanesulfonyl) imide,
*²Lithium tetrafluoroborate,
*³Lithium perchlorate,
*⁴Lithium bis (fluorosulfonyl) imide,
*⁵Sulfolane
*⁶Dimethylsulfone,
*⁷3-methylsulfolane,
*⁸Ethylmethylsulfone

The electrolyte of Examples 15 to 20 includes: UiO-67 as the porous insulator having a pore; and any of SL, DMSO2, MSL, and EMS as the sulfonyl group-containing medium and LiTFSI, LiBF₄, LiClO₄, and LiFSI as the metal salt that are disposed in the pore, wherein the metal salt is at least one selected from a group consisting of an alkali metal salt and an alkaline earth metal salt, and the molar ratio of the medium to the metal salt (medium/metal salt) is 0.1 to 2.0. That is, the electrolyte of Examples 15 to 20 was encompassed in the scope of the disclosure.

The ionic conductivity of the electrolyte of Examples 15 to 20 was 2.7×10⁻⁴ to 3.5×10⁻⁴ S/cm at normal temperature (room temperature).

### Examples 21 to 28 and Comparative Examples 6 to 7: EC-LiFSI/UiO-67-Based

### (Ionic Conductivity)

The electrolytic solution of each of Examples 21 to 28 was prepared and the ionic conductivity was measured in the same manner as in Example 1 except that the medium was changed from sulfolane (SL) to ethylene carbonate (EC) (manufactured by KISHIDA CHEMICAL CO., LTD., and the molar ratio (EC/LiFSI) listed in Table 4 was employed. In addition, the appearance of the electrolytic solution obtained in the electrolytic solution preparation step was also observed. These results are shown in Table 4.

TABLE 4

| | | State of | Ionic |
|---|---|---|---|
| | | electrolytic | conductivity |
| | | solution*³ | at room |
| | Molar ratio | at room | temperature |
| | (EC*¹/LiFSI*²) | temperature | (S/cm) |
| Comparative | 10.0 | Liquid | 2.7 × 10⁻⁴ |
| Example 6 | | | |
| Comparative | 4.0 | Liquid | 2.9 × 10⁻⁴ |
| Example 7 | | | |
| Example 21 | 2.0 | Liquid | 5.1 × 10⁻⁴ |
| Example 22 | 1.5 | Sherbet | 6.5 × 10⁻⁴ |
| Example 23 | 1.0 | Sherbet | 6.8 × 10⁻⁴ |
| Example 24 | 0.8 | Solid | 9.2 × 10⁻⁴ |
| Example 25 | 0.5 | Solid | 10.0 × 10⁻⁴ |
| Example 26 | 0.3 | Solid | 5.1 × 10⁻⁴ |
| Example 27 | 0.2 | Solid | 4.0 × 10⁻⁴ |
| Example 28 | 0.1 | Solid | 3.7 × 10⁻⁴ |

*¹Ethylene carbonate,
*²Lithium bis (fluorosulfonyl) imide,
*³Electrolytic solution made of metal salt and medium used in each example

Table 4 shows the molar ratio (EC/LiFSI) and ionic conductivity at room temperature. FIG. 5 was created based on Table 4. FIG. 5 shows the relationship between molar ratio (EC/LiFSI) and ionic conductivity at room temperature. In the EC-LiFSI-based electrolyte, as shown in FIG. 5, the ionic conductivity simply increased at room temperature as the molar ratio (EC/LiFSI) increased from 0.1 to 0.5, the ionic conductivity simply decreased at room temperature as the molar ratio (EC/LiFSI) increased from 0.5 to 4.0, and the ionic conductivity was almost constant at room temperature as the molar ratio (EC/LiFSI) increased from 4.0 to 10.0.

The electrolyte of Examples 21 to 28 includes: UiO-67 as the porous insulator having a pore; and EC as the medium and LiFSI as the metal salt that are disposed in the pore, wherein LiFSI as the metal salt is at least one selected from a group consisting of an alkali metal salt and an alkaline earth metal salt, and the molar ratio of the medium to the metal salt (medium/metal salt) is 0.1 to 2.0. That is, the electrolyte of Examples 21 to 28 was encompassed in the scope of the disclosure.

The ionic conductivity of the electrolyte of Examples 21 to 28 was 3.7×10⁻⁴ to 10×10⁻⁴ S/cm at room temperature.

The electrolyte of Comparative Examples 6 to 7 was not encompassed in the scope of the disclosure. Specifically, in the electrolyte of Comparative Examples 6 to 7, the molar ratio of the medium to the metal salt (medium/metal salt) was more than 2.0.

The ionic conductivity of the electrolyte of Comparative Examples 6 to 7 was 2.7×10⁻⁴ to 2.9×10⁻⁴ S/cm at room temperature.

Examples 21 to 28, each of which is encompassed in the scope of the disclosure, had higher ionic conductivity at room temperature than Comparative Examples 6 to 7, each of which is not encompassed in the scope of the disclosure.

The integral value of the graph showing ionic conductivity in FIG. 5 was larger than the integral value of the graph showing ionic conductivity in FIG. 4. Therefore, it is found that the electrolyte of Examples 21 to 28 exhibits higher ionic conductivity than the electrolyte of Examples 1 to 8 (That is, the EC-LiSFI-based electrolyte has higher ionic conductivity than the SL-LiSFI-based electrolyte.).

### (Structural Analysis by Raman Spectroscopy)

### —First Bridge Structure—

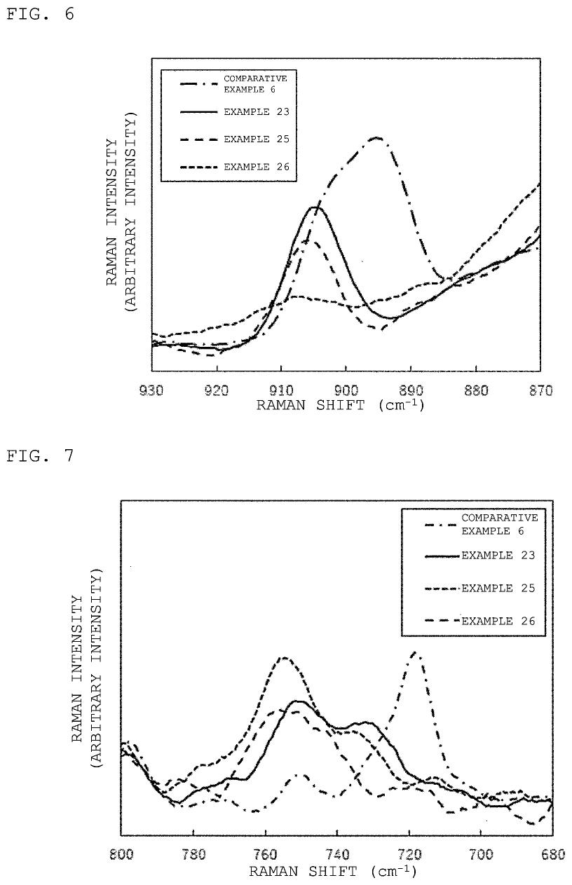

Further, for the electrolytes of Examples 23 and 25 to 26 and Comparative Example 6, the electrolyte was subjected to structural analysis by Raman spectroscopy in the same manner as in Example 1. FIG. 6 shows Raman spectrums of the electrolytes of Examples 23 and 25 to 26 and Comparative Example 6 at 870 to 930 cm⁻¹. In the Raman spectrums shown in FIG. 6, the vertical axis represents Raman intensity (unit: arbitrary intensity), and the horizontal axis represents Raman shift (unit: cm⁻¹). The Raman spectrums shown in FIG. 6 had a peak around 900 to 910 cm⁻¹. This peak was assigned to the peak that is derived from ring respiratory vibration (respiratory vibration of heterocycle) of ethylene carbonate (EC) and originally positioned around 895 cm⁻¹, and has been shifted to the higher wave number side.

In the EC-LiFSI-based electrolyte, as shown in FIG. 6, the peak (Raman scattering peak) derived from respiratory vibration of the heterocycle of EC was mainly present as one peak and located at 900 to 910 cm⁻¹ when the molar ratio (EC/LiFSI) was 0.3 to 1.0 (Examples 23 and 25 to 26). That is, in the electrolytes of Examples 23 and 25 to 26, the peak that is derived from the respiratory vibration and has been shifted to the higher wave number side was observed.

On the other hand, the peak derived from the respiratory vibration was present as two peaks, which were each positioned around 895 cm⁻¹ and 900 to 910 cm⁻¹ (shoulder), when the molar ratio (EC/LiFSI) is 10 (Comparative Example 6). That is, in the electrolyte of Comparative Example 6, the peak derived from the respiratory vibration was mainly observed, and the peak shifted to the higher wave number side was slightly observed.

From the results in FIG. 6, it is considered that, in the electrolyte of Examples 23 and 25 to 26, Li⁺ constituting the metal salt and EC as the medium form the first bridge structure. This bridge structure is presumably due to the molar ratio (EC/LiFSI).

### —Second Bridge Structure—

FIG. 7 is Raman spectrums of the electrolytes of Examples 23 and 25 to 26 and Comparative Example 6 at 680 to 800 cm⁻¹. In the Raman spectrums shown in FIG. 7, the vertical axis represents Raman intensity (unit: arbitrary intensity), and the horizontal axis represents Raman shift (unit: cm⁻¹). The Raman spectrums shown in FIG. 7 had a peak around 740 to 760 cm⁻¹. The peak was assigned to the peak that is derived from S—N—S stretching vibration of the FSI anion and originally positioned around 710 to 740 cm⁻¹, and has been shifted to the higher wave number side.

In the EC-LiFSI-based electrolyte, as shown in FIG. 7, the peak (Raman scattering peak) derived from SNS stretching vibration of the FSI anion was mainly present as the peak that is derived from the stretching vibration and has been shifted to the higher wave number side, when the molar ratio (EC/LiFSI) was 0.3 to 1.0 (Examples 23 and 25 to 26). That is, in the electrolytes of Examples 23 and 25 to 26, the peak that is derived from the bending vibration and has been shifted to the higher wave number side was mainly observed.

On the other hand, the peak derived from the stretching vibration was mainly present as the peak derived from the stretching vibration when the molar ratio (EC/LiFSI) is 10 (Comparative Example 6). That is, in the electrolyte of Comparative Example 6, the peak derived from the respiratory vibration was mainly observed.

From the results in FIG. 7, it is considered that, in the electrolyte of Examples 23 and 25 to 26, Li⁺ and the FSI anion constituting the metal salt form the second bridge structure. The second bridge structure is presumably due to the molar ratio (EC/LiFSI).

### Examples 29 to 32: EC-LiFSI/MOF-Based

The electrolyte of each of Examples 29 to 32 was prepared and the ionic conductivity was measured in the same manner as in Example 1 except that sulfolane (SL) as the medium was changed to ethylene carbonate (EC) (manufactured by KISHIDA CHEMICAL CO., LTD., the molar ratio (SL/LiSFI) was changed to the molar ratio (EC/LiFSI) shown in Table 5, and UiO-67 as the porous insulator was changed to the metal organic framework (MOF) shown in Table 5. These results are shown in Table 5.

TABLE 5

| | | | Ionic |
|---|---|---|---|
| | | | conductivity |
| | Porous | | at room |
| | insulator | Molar ratio | temperature |
| | (MOF) | (EC*¹/LiFSI*²) | (S/cm) |
| Example 29 | HKUST-1 | 0.5 | 8.7 × 10⁻⁴ |
| Example 30 | ZIF-8 | 0.5 | 7.3 × 10⁻⁴ |
| Example 31 | MIL-100(Fe) | 0.5 | 5.5 × 10⁻⁴ |
| Example 32 | MIL-53 | 0.5 | 5.1 × 10⁻⁴ |

*¹Ethylene carbonate,
*²Lithium bis (fluorosulfonyl) imide

The electrolyte of Examples 29 to 32 includes: any of HKUST-1, ZIF-8, MIL-100 (Fe), and MIL-53 as the porous insulator (metal organic framework) having a pore; and EC as the medium and LiFSI as the metal salt that are disposed in the pore, wherein LiFSI as the metal salt is at least one selected from a group consisting of an alkali metal salt and an alkaline earth metal salt, and the molar ratio of the medium to the metal salt (medium/metal salt) is 0.1 to 2.0. That is, the electrolyte of Examples 29 to 32 was encompassed in the scope of the disclosure.

### Examples 33 to 40 and Comparative Examples 8 to 9: EC-LiFSI/Zeolite-Based

The electrolyte of each of Examples 33 to 40 and Comparative Examples 8 to 9 was prepared and the ionic conductivity was measured in the same manner as in Example 1 except that sulfolane (SL) as the medium was changed to ethylene carbonate (EC) (manufactured by KISHIDA CHEMICAL CO., LTD.), the molar ratio (SL/LiSFI) was changed to the molar ratio (EC/LiFSI) shown in Table 6, UiO-67 as the porous insulator was changed to HS-690, a zeolite, and the drying temperature under vacuum for the porous insulator was changed from 250° C. to 300° C. In addition, the appearance of the electrolytic solution obtained in the electrolytic solution preparation step was also observed. These results are shown in Table 6.

TABLE 6

| | | State of | Ionic |
|---|---|---|---|
| | | electrolytic | conductivity |
| | | solution*³ | at room |
| | Molar ratio | at room | temperature |
| | (EC*¹/LiFSI*²) | temperature | (S/cm) |
| Comparative | 10.0 | Liquid | 2.8 × 10⁻⁴ |
| Example 8 | | | |
| Comparative | 4.0 | Liquid | 2.5 × 10⁻⁴ |
| Example 9 | | | |
| Example 33 | 2.0 | Liquid | 15 × 10⁻⁴ |
| Example 34 | 1.5 | Sherbet | 21 × 10⁻⁴ |
| Example 35 | 1.0 | Sherbet | 29 × 10⁻⁴ |
| Example 36 | 0.8 | Solid | 33 × 10⁻⁴ |
| Example 37 | 0.5 | Solid | 36 × 10⁻⁴ |
| Example 38 | 0.3 | Solid | 54 × 10⁻⁴ |
| Example 39 | 0.2 | Solid | 22 × 10⁻⁴ |
| Example 40 | 0.1 | Solid | 9.7 × 10⁻⁴ |

*¹Ethylene carbonate,
*²Lithium bis (fluorosulfonyl) imide,
*³Electrolytic solution made of metal salt and medium used in each example

The electrolyte of Examples 33 to 40 includes: HS-690 as the porous insulator (zeolite) having a pore; and EC as the medium and LiFSI as the metal salt that are disposed in the pore, wherein LiFSI as the metal salt is at least one selected from a group consisting of an alkali metal salt and an alkaline earth metal salt, and the molar ratio of the medium to the metal salt (medium/metal salt) is 0.1 to 2.0. That is, the electrolyte of Examples 29 to 32 was encompassed in the scope of the disclosure.

The ionic conductivity of the electrolyte of Examples 33 to 40 was 9.7×10⁻⁴ to 54×10⁻⁴ S/cm at room temperature.

That is, the electrolyte of Comparative Examples 8 to 9 was not encompassed in the scope of the disclosure. Specifically, in the electrolyte of Comparative Examples 8 to 9, the molar ratio of the medium to the metal salt (medium/metal salt) was more than 2.0.

The ionic conductivity of the electrolyte of Comparative Examples 8 to 9 was 2.5×10⁻⁴ to 2.8×10⁻⁴ S/cm at room temperature.

Examples 33 to 40, each of which is encompassed in the scope of the disclosure, had higher ionic conductivity at room temperature than Comparative Examples 8 to 9, each of which is not encompassed in the scope of the disclosure.

In addition, the battery of Example 37 was produced in the same manner as in the battery of Example 1 (cell for measuring ionic conductivity) except that the electrolyte was changed to the electrolyte of Example 37, Li₄Ti₅O₁₂ was used as the negative electrode, and LiFePO₄ was used as the positive electrode. For the obtained battery of Example 37, charge-discharge was performed at a current of 0.1 C. It was found that the battery of Example 37 was capable of charge-discharge at about 1.8 V.

### Examples 41 to 44: EC-LiFSI/Zeolite-Based

The electrolyte of each of Examples 41 to 46 was prepared and the ionic conductivity was measured in the same manner as in Example 1 except that sulfolane (SL) as the medium was changed to ethylene carbonate (EC) (manufactured by KISHIDA CHEMICAL CO., LTD.), the molar ratio (SL/LiSFI) was changed to the molar ratio (EC/LiFSI) shown in Table 7, and UiO-67 as the porous insulator was changed to a zeolite (any of HS-320 (H), HSZ-360HUA, HSZ-660HOA, HSZ-385HUA, HSZ-980HOA, and HSZ-390HUA). These results are shown in Table 7.

TABLE 7

| | | | | Ionic |
|---|---|---|---|---|
| | | Porous insulator | | conductivity |
| | | (zeolite) | | at room |
| | Molar ratio | Product name | Si/Al | temperature |
| | (EC*¹/LiFSI*²) | (type number) | ratio | (S/cm) |
| Example 41 | 0.3 | HS-320(H) | 5.5 | 1.1 × 10⁻³ |
| Example 42 | 0.3 | HSZ-360HUA | 15 | 2.3 × 10⁻³ |
| Example 43 | 0.3 | HSZ- 660HOA | 30 | 2.8 × 10⁻³ |
| Example 44 | 0.3 | HSZ-385HUA | 100 | 4.6 × 10⁻³ |
| Example 45 | 0.3 | HSZ-980HOA | 500 | 5.9 × 10⁻³ |
| Example 46 | 0.3 | HSZ-390HUA | 770 | 8.5 × 10⁻³ |

*¹Ethylene carbonate,
*²Lithium bis (fluorosulfonyl) imide

The electrolyte of Examples 41 to 46 includes: any of HS-320 (H), HSZ-360HUA, HSZ-660HOA, HSZ-385HUA, HSZ-980HOA, and HSZ-390HUA as the porous insulator (zeolite) having a pore; and EC as the medium and LiFSI as the metal salt that are disposed in the pore, wherein LiFSI as the metal salt is at least one selected from a group consisting of an alkali metal salt and an alkaline earth metal salt, and the molar ratio of the medium to the metal salt (medium/metal salt) is 0.1 to 2.0. That is, the electrolyte of Examples 41 to 46 was encompassed in the scope of the disclosure.

The ionic conductivity of the electrolyte of each of Examples 41 to 46 was 1.1×10⁻³ to 8.5×10⁻³ S/cm at room temperature, and increased as the Si/Al ratio was increased. This trend suggests that: the higher the Si/Al ratio, the more silanol groups present on the pore inner wall of the porous insulator, resulting in more hopping sites for carriers (Li⁺).

The ionic conductivity of the electrolyte of each of Examples 41 to 46 (EC-LiFSi/zeolite-based, molar ratio: 0.3) is 1.1×10⁻³ to 8.5×10⁻³ S/cm. On the other hand, the ionic conductivity of the electrolyte of Example 6 (EC-LiFSi/metal organic framework-based, molar ratio: 0.3) is 1.01×10⁻³ S/cm. Therefore, it is found that, when the porous insulator is zeolite-based, the ionic conductivity can be further improved as compared with the metal organic framework-based porous insulator.

### Examples 48 to 63: Alkali Metal Salt-Medium/Zeolite (HS-690)-Based

The electrolyte of each of Examples 48 to 63 was prepared and the ionic conductivity was measured in the same manner as in Example 1 except that sulfolane (SL) as the medium was changed to the medium as shown in Table 8, LiSFI as the metal salt was changed to the alkali metal salt as shown in Table 8, and UiO-67 as the porous insulator was changed to a zeolite (HS-690). These results are shown in Table 8.

TABLE 8

| | | | | Ionic |
|---|---|---|---|---|
| | | | Molar ratio | conductivity |
| | Alkali | | (Medium/Alkali | at room |
| | metal | | metal salt | temperature |
| | salt | Medium | ratio) | (S/cm) |
| Example 48 | LiFSI*¹ | PC*⁶ | 1.0 | 8.8 × 10⁻⁴ |
| Example 49 | LiFSI | PC | 0.5 | 10 × 10⁻⁴ |
| Example 50 | LiFSI | VC*⁷ | 1.0 | 12 × 10-4 |
| Example 51 | LiFSI | VC | 0.5 | 79 × 10⁻⁴ |
| Example 52 | LiFSI | FEC*⁸ | 1.0 | 10 × 10⁻⁴ |
| Example 53 | LiFSI | FEC | 0.5 | 32 × 10⁻⁴ |
| Example 54 | LiTFSI*² | EC*⁹ | 1.0 | 9.8 × 10⁻⁴ |
| Example 55 | LiPF6*³ | EC | 1.0 | 7.8 × 10⁻⁴ |
| Example 56 | LiBF4*⁴ | EC | 1.0 | 10 × 10⁻⁴ |
| Example 57 | LiClO4*⁵ | EC | 0.5 | 6.3 × 10⁻⁴ |
| Example 58 | LiFSI | GBL*¹⁰ | 1.0 | 26 × 10⁻⁴ |
| Example 59 | LiFSI | GBL | 0.5 | 9.7 × 10⁻⁴ |
| Example 60 | LiFSI | GBL | 0.3 | 73 × 10⁻⁴ |
| Example 61 | LiFSI | Diglyme | 1.0 | 8.9 × 10⁻⁴ |
| Example 62 | LiFSI | Diglyme | 0.5 | 22 × 10⁻⁴ |
| Example 63 | LiFSI | DME*¹¹ | 0.5 | 4.5 × 10⁻⁴ |

*¹Lithium bis (fluorosulfonyl) imide,
*²Bis (trifluoromethanesulfonyl) imide,
*³Lithium hexafluorophosphate,
*⁴Lithium tetrafluoroborate,
*⁵Lithium perchlorate,
*⁶Propylene carbonate,
*⁷Vinylene carbonate,
*⁸Fluoroethylene carbonate,
*⁹Ethylene carbonate,
*¹⁰γ-butyrolactone,
*¹¹1,2-dimethoxyethane

The electrolyte of Examples 48 to 63 includes: HS-690 as the porous insulator (zeolite) having a pore; and any of PC, VC, FEC, EC, GBL, diglyme, and DME as the medium and any of LiFSI, LiTFSI, LiPF6, LiBF4, and LiClO4 as the metal salt that are disposed in the pore, wherein the molar ratio of the medium to the metal salt (medium/metal salt) is 0.1 to 2.0. That is, the electrolyte of Examples 48 to 63 was encompassed in the scope of the disclosure.

### Examples 64 to 69: EC-LiFSI/Mesoporous Silica-Based

The electrolyte of each of Examples 64 to 69 was prepared and the ionic conductivity was measured in the same manner as in Example 1 except that sulfolane (SL) as the medium was changed to the medium as shown in Table 9, and UiO-67 as the porous insulator was changed to the mesoporous silica as shown in Table 9. These results are shown in Table 9.

TABLE 9

| | | | Ionic |
|---|---|---|---|
| | | Porous | conductivity |
| | | insulator | at room |
| | Molar ratio | (Mesoporous | temperature |
| | (EC*¹/LiFSI*²) | silica) | (S/cm) |
| Example 64 | 1.0 | MCM-48 | 2.9 × 10⁻³ |
| Example 65 | 0.5 | MCM-48 | 3.1 × 10⁻³ |
| Example 66 | 0.3 | MCM-48 | 5.3 × 10⁻³ |
| Example 67 | 0.5 | SBA-15 | 3.5 × 10⁻³ |
| Example 68 | 0.5 | MCM-41 | 3.7 × 10⁻³ |
| Example 69 | 0.5 | SBA-16 | 3.4 × 10⁻³ |

*¹Ethylene carbonate,
*²Lithium bis (fluorosulfonyl) imide

The electrolyte of Examples 64 to 69 includes: any of MCM-48, SBA-15, MCM-41, and SBA-16 as the porous insulator (mesoporous silica) having a pore; and EC as the medium and LiFSI as the metal salt that are disposed in the pore, wherein the molar ratio of the medium to the metal salt (medium/metal salt) is 0.1 to 2.0. That is, the electrolyte of Examples 64 to 69 was encompassed in the scope of the disclosure.

The ionic conductivity of the electrolyte of each of Examples 65 and 67 to 69 (EC-LiFSi/mesoporous silica-based, molar ratio: 0.5) is 3.1×10⁻³ to 3.7×10⁻³ S/cm. On the other hand, the ionic conductivity of the electrolyte of Example 5 (EC-LiFSi/metal organic framework-based, molar ratio: 0.5) is 0.94×10⁻³ S/cm. Therefore, it is found that, when the porous insulator is mesoporous silica-based, the ionic conductivity can be further improved as compared with the metal organic framework-based porous insulator.

### Examples 71 to 80 and Comparative Example 10: SL-LiFSI/Zeolite-Based

The electrolyte of each of Examples 71 to 80 was prepared and the ionic conductivity was measured in the same manner as in Example 1 except that UiO-67 as the porous insulator was changed to the zeolite as shown in Table 10, and the molar ratio (SL-LiFSI) was changed to the molar ratio as shown in Table 10. These results are shown in Table 10.

TABLE 10

| | | | | Ionic |
|---|---|---|---|---|
| | | Porous insulator | | conductivity |
| | | (zeolite) | | at room |
| | Molar ratio | Product name | Si/Al | temperature |
| | (SL*¹/LiFSI*²) | (type number) | ratio | (S/cm) |
| Comparative | 9.6 | HS-690 | 180 | 1.1 × 10⁻⁴ |
| Example 10 | | | | |
| Example 71 | 1.0 | HS-690 | 180 | 9.7 × 10⁻⁴ |
| Example 72 | 0.5 | HS-690 | 180 | 22 × 10⁻⁴ |
| Example 73 | 0.3 | HS-690 | 180 | 42 × 10⁻⁴ |
| Example 74 | 0.2 | HS-690 | 180 | 26 × 10⁻⁴ |
| Example 75 | 0.1 | HS-690 | 180 | 8.9 × 10⁻⁴ |
| Example 76 | 0.5 | HS-642 | 18 | 3.3 × 10⁻⁴ |
| Example 77 | 1.0 | HS-320(Na) | 5.5 | 6.4 × 10⁻⁴ |
| Example 78 | 0.5 | HS-320(Na) | 5.5 | 10 × 10⁻⁴ |
| Example 79 | 0.5 | HSZ-980HOA | 500 | 20 × 10⁻⁴ |
| Example 80 | 0.5 | HSZ-840HOA | 40 | 9.0 × 10⁻⁴ |

*¹Sulfolane,
*²Lithium bis (fluorosulfonyl) imide

The electrolyte of Examples 71 to 80 includes: any of HS-690, HS-642, HS-320 (Na), HSZ-980HOA, and HSZ-840HOA as the porous insulator (zeolite) having a pore; and SL as the medium and LiFSI as the metal salt that are disposed in the pore, wherein the molar ratio of the medium to the metal salt (medium/metal salt) is 0.1 to 2.0. That is, the electrolyte of Examples 71 to 80 was encompassed in the scope of the disclosure.

The ionic conductivity of the electrolyte of Examples 71 to 80 was 3.3×10⁻⁴ to 42×10⁻⁴ S/cm at room temperature.

The electrolyte of Comparative Example 10 was not encompassed in the scope of the disclosure. Specifically, in the electrolyte of Comparative Example 10, the molar ratio of the medium to the metal salt (medium/metal salt) was more than 2.0. The ionic conductivity of the electrolyte of Comparative Example 10 was 1.1×10⁻⁴ S/cm at room temperature.

Examples 71 to 80, each of which is encompassed in the scope of the disclosure, had higher ionic conductivity at room temperature than Comparative Example 10, which is not encompassed in the scope of the disclosure.

The integral value of the graph (not shown) showing ionic conductivity in Examples 71 to 75 (SL-LiFSI/zeolite-based, molar ratio: 0.1 to 1.0) in Table 10 was larger than the integral value of the graph (FIG. 4) showing ionic conductivity in Examples 4 to 8 (SL-LiFSI/metal organic framework-based, molar ratio: 0.1 to 1.0) in Table 1. Therefore, it is found that the electrolyte of Examples 71 to 75 exhibits higher ionic conductivity than the electrolyte of Examples 4 to 8 (That is, the zeolite-based electrolyte has higher ionic conductivity than the metal organic framework-based electrolyte.).

### Examples 81 to 87 and Comparative Example 11: SL-LiFSI/Mesoporous Silica-Based

The electrolyte of each of Examples 81 to 87 and Comparative Example 11 was prepared and the ionic conductivity was measured in the same manner as in Example 1 except that UiO-67 as the porous insulator was changed to the mesoporous silica as shown in Table 11, and the molar ratio (SL/LiFSI) was changed to the molar ratio as shown in Table 11. These results are shown in Table 11.

TABLE 11

| | | | Ionic |
|---|---|---|---|
| | | Porous | conductivity |
| | | insulator | at room |
| | Molar ratio | (Mesoporous | temperature |
| | (SL*¹/LiFSI*²) | silica) | (S/cm) |
| Comparative | 9.6 | MCM-48 | 0.82 × 10⁻⁴ |
| Example 11 | | | |
| Example 81 | 1.0 | MCM-48 | 18 × 10⁻⁴ |
| Example 82 | 0.5 | MCM-48 | 86 × 10⁻⁴ |
| Example 83 | 0.3 | MCM-48 | 95 × 10⁻⁴ |
| Example 84 | 0.2 | MCM-48 | 120 × 10⁻⁴ |
| Example 85 | 0.3 | SBA-15 | 77 × 10⁻⁴ |
| Example 86 | 0.3 | MCM-41 | 80 × 10⁻⁴ |
| Example 87 | 0.3 | SBA-16 | 71 × 10⁻⁴ |

*¹Sulfolane,
*²Lithium bis (fluorosulfonyl) imide

The electrolyte of Examples 81 to 87 includes: any of MCM-48, SBA-15, MCM-41, and SBA-16 as the porous insulator (mesoporous silica) having a pore; and SL as the medium and LiFSI as the metal salt that are disposed in the pore, wherein the molar ratio of the medium to the metal salt (medium/metal salt) is 0.1 to 2.0. That is, the electrolyte of Examples 81 to 87 was encompassed in the scope of the disclosure.

The ionic conductivity of the electrolyte of Examples 81 to 87 was 18×10⁻⁴ to 120×10⁻⁴ S/cm at room temperature.

The electrolyte of Comparative Example 11 was not encompassed in the scope of the disclosure. Specifically, in the electrolyte of Comparative Example 11, the molar ratio of the medium to the metal salt (medium/metal salt ratio) was more than 2.0. The ionic conductivity of the electrolyte of Comparative Example 11 was 0.82× 10⁻⁴ S/cm at room temperature.

Examples 81 to 87, each of which is encompassed in the scope of the disclosure, had higher ionic conductivity at room temperature than Comparative Example 11, which is not encompassed in the scope of the disclosure.

The integral value of the graph (not shown) showing ionic conductivity in Examples 81 to 84 (SL-LiFSI/mesoporous silica-based, molar ratio: 0.2 to 1.0) in Table 11 was larger than the integral value of the graph (FIG. 4) showing ionic conductivity in Examples 4 to 7 (SL-LiFSI/metal organic framework-based, molar ratio: 0.2 to 1.0) in Table 1. Therefore, it is found that the electrolyte of Examples 81 to 84 exhibits higher ionic conductivity than the electrolyte of Examples 4 to 7 (That is, the mesoporous silica-based electrolyte has higher ionic conductivity than the metal organic framework-based electrolyte.).

Embodiments of the electrolyte and the battery according to the present disclosure are as follows.

<1> An electrolyte including: a porous insulator having a pore; and a medium and a metal salt that are disposed in the pore, wherein the metal salt is at least one of an alkali metal salt and an alkaline earth metal salt, and a molar ratio of the medium to the metal salt (medium/metal salt) is 0.1 to 2.0.

<2> The electrolyte according to <1>, wherein the medium is at least one of: a sulfonyl-based medium selected from sulfolane, dimethylsulfone, 3-methylsulfone, and ethylmethylsulfone; a carbonate-based medium selected from ethylene carbonate, propylene carbonate, vinylene carbonate, and fluoroethylene carbonate; a chain ether-based medium selected from 1,2-diethoxyethane and diglyme; a lactone-based medium selected from γ-butyrolactone and δ-valerolactone; and a cyclic ether-based medium selected from 1,3-dioxolane and 1,3-dioxane.

<3> The electrolyte according to <1> or <2>, wherein the metal salt is a lithium salt.

<4> The electrolyte according to any one of <1> to <3>, wherein the porous insulator is at least one of a metal organic framework, a zeolite, and a mesoporous silica.

<5> The electrolyte according to any one of <1> to <4>, wherein a positive ion constituting the metal salt is Li⁺, K⁺, Na⁺, or Mg²⁺.

<6> The electrolyte according to any one of <1> to <5>, wherein a negative ion constituting the metal salt is at least one of a bis(fluorosulfonyl) imide ion, a TFSI ion, a tetrafluoroborate ion, and a perchlorate ion.

<7> The electrolyte according to any one of <1> to <6>, wherein the electrolyte is a solid electrolyte.

<8> The electrolyte according to any one of <1> to <7>, wherein the medium is at least one sulfonyl-based medium having a sulfonyl group selected from sulfolane, dimethylsulfone, 3-methylsulfone, and ethylmethylsulfone, and a in Raman spectrum, the sulfonyl group has a peak derived from SO₂ bending vibration and shifted to a higher wave number side.

<9> The electrolyte according to any one of <1> to <8>, wherein a negative ion constituting the metal salt is a bis(fluorosulfonyl) imide ion or a bis(trifluoromethanesulfonyl) imide ion, and in a Raman spectrum, the negative ion constituting the metal salt has a peak derived from S—N—S stretching vibration and shifted to a higher wave number side.

<10> The electrolyte according to any one of <1> to <9>, wherein the porous insulator is one of a zeolite or a mesoporous silica.

<11> The electrolyte according to any one of <1> to <10>, wherein the porous insulator is one of a zeolite or a mesoporous silica, and the zeolite or the mesoporous silica have a Si/Al ratio of 5.0 or more.

<12> The electrolyte according to any one of <1> to <11>, wherein the medium is at least one carbonate-based medium selected from ethylene carbonate, propylene carbonate, vinylene carbonate, and fluoroethylene carbonate.

<13> The electrolyte according to any one of <1> to <12>, wherein the medium is at least one carbonate-based medium selected from ethylene carbonate, propylene carbonate, vinylene carbonate, and fluoroethylene carbonate, and in a Raman spectrum, a heterocycle of the carbonate-based medium has a peak derived from respiratory vibration and shifted to a higher wave number side.

<14> A battery including the electrolyte according to any one of <1> to <13>.

The battery including the electrolyte according to the present disclosure can be used in various fields in which power storage is assumed. Although it is merely an example, the battery (especially, secondary battery) including the electrolyte of the present disclosure can be used in the fields of electricity, information, and communication in which electric and electronic equipment and the like are used (for example, electric and electronic equipment fields or mobile equipment fields including mobile phones, smartphones, notebook computers and digital cameras, activity meters, arm computers, electronic papers, and wearable devices, and small electronic machines such as RFID tags, card type electronic money, and smartwatches), home and small industrial applications (for example, the fields of electric tools, golf carts, and home, nursing, and industrial robots), large industrial applications (for example, fields of forklift, elevator, and harbor crane), transportation system fields (for example, the fields of hybrid automobiles, electric automobiles, buses, trains, power-assisted bicycles, and electric two-wheeled vehicles), power system applications (for example, fields such as various types of power generation, road conditioners, smart grids, and household power storage systems), medical applications (medical equipment fields such as earphone hearing aids), pharmaceutical applications (fields such as dosage management systems), IoT fields, space and deep sea applications (for example, fields such as a space probe and a submersible), and the like.

1. An electrolyte comprising:
a porous insulator having a pore; and
a medium and a metal salt that are disposed in the pore, wherein
the metal salt is at least one of an alkali metal salt and an alkaline earth metal salt, and
a molar ratio of the medium to the metal salt is 0.1 to 2.0.

2. The electrolyte according to claim 1, wherein the molar ratio of the medium to the metal salt is 0.1 to 0.8.

3. The electrolyte according to claim 1, wherein the molar ratio of the medium to the metal salt is 0.3 to 1.5.

4. The electrolyte according to claim 1, wherein the medium is at least one of:
a sulfonyl-based medium selected from sulfolane, dimethylsulfone, 3-methylsulfone, and ethylmethylsulfone;
a carbonate-based medium selected from ethylene carbonate, propylene carbonate, vinylene carbonate, and fluoroethylene carbonate;
a chain ether-based medium selected from 1,2-diethoxyethane and diglyme;
a lactone-based medium selected from γ-butyrolactone and δ-valerolactone; and
a cyclic ether-based medium selected from 1,3-dioxolane and 1,3-dioxane.

5. The electrolyte according to claim 1, wherein the metal salt is a lithium salt.

6. The electrolyte according to claim 1, wherein the porous insulator is at least one of a metal organic framework, a zeolite, and a mesoporous silica.

7. The electrolyte according to claim 1, wherein a positive ion constituting the metal salt is Li⁺, K⁺, Na⁺, or Mg²⁺.

8. The electrolyte according to claim 1, wherein a negative ion constituting the metal salt is at least one of a bis(fluorosulfonyl) imide ion, a bis(trifluoromethanesulfonyl) imide ion, a tetrafluoroborate ion, and a perchlorate ion.

9. The electrolyte according to claim 1, wherein the electrolyte is a solid electrolyte.

10. The electrolyte according to claim 1, wherein
the medium is at least one sulfonyl-based medium having a sulfonyl group selected from sulfolane, dimethylsulfone, 3-methylsulfone, and ethylmethylsulfone, and
in a Raman spectrum, the sulfonyl group has a peak derived from SO₂ bending vibration and shifted to a higher wave number side.

11. The electrolyte according to claim 1, wherein
a negative ion constituting the metal salt is a bis (fluorosulfonyl) imide ion or a bis (trifluoromethanesulfonyl) imide ion, and
in a Raman spectrum, the negative ion constituting the metal salt has a peak derived from S—N—S stretching vibration and shifted to a higher wave number side.

12. The electrolyte according to claim 1, wherein the porous insulator is one of a zeolite or a mesoporous silica.

13. The electrolyte according to claim 1, wherein
the porous insulator is one of a zeolite or a mesoporous silica, and
the zeolite or the mesoporous silica has a Si/Al ratio of 5.0 or more.

14. The electrolyte according to claim 13, wherein the Si/Al ratio is 5 to 10,000.

15. The electrolyte according to claim 1, wherein the medium is a carbonate-based medium selected from ethylene carbonate, propylene carbonate, vinylene carbonate, and fluoroethylene carbonate.

16. The electrolyte according to claim 1, wherein
the medium is at least one carbonate-based medium selected from ethylene carbonate, propylene carbonate, vinylene carbonate, and fluoroethylene carbonate, and
in a Raman spectrum, a heterocycle of the carbonate-based medium has a peak derived from respiratory vibration and shifted to a higher wave number side.

17. The electrolyte according to claim 1, wherein the metal salt and the medium form a bridge structure in which the medium and a positive ion of the metal salt are alternately arranged.

18. The electrolyte according to claim 1, wherein the metal salt and the medium form a bridge structure in which a positive ion of the metal salt and a negative ion of the metal salt are alternately arranged.

19. A battery comprising the electrolyte according to claim 1.
